(19) United States
(12) Patent Application Publication
(10) Pub. No.: US 2017/0102011 A1
(43) Pub. Date: Apr. 13, 2017

(54) HYDRAULIC DRIVE DEVICE FOR A MOLDING MACHINE

(71) Applicant: ENGEL AUSTRIA GmbH, Schwertberg (AT)

(72) Inventors: Anton LOHNECKER, Ertl (AT); Helmut STEINPARZER, Steyr (AT); Herbert ZEIDLHOFER, Haag (AT)

(21) Appl. No.: 15/287,965

(22) Filed: Oct. 7, 2016

(30) Foreign Application Priority Data
Oct. 8, 2015 (AT) A 50863/2015

(51) Int. Cl. F15B 13/04; F15B 11/08

(52) U.S. Cl. CPC F15B 13/0401; F15B 11/08; F15B 2211/20538; F15B 2211/20569; F15B 2211/20576; F15B 2211/30525; F15B 2211/20515; F15B 2211/7058

(57) ABSTRACT

A hydraulic drive device for a molding machine includes at least one motor, such as an electric motor, at least one first hydraulic pump which can be driven by the at least one motor, and at least one flywheel. At least one second hydraulic pump is connected, or can be connected, with the at least one flywheel, and a hydraulic connection conduct is provided between the first hydraulic pump and the second hydraulic pump.

The invention concerns a hydraulic drive device, in particular for a molding machine, comprising at least one motor, in particular an electric motor, at least one first hydraulic pump which can be driven by the at least one motor, and at least one flywheel. Further, the invention concerns a molding machine with such a hydraulic drive device and method for operating a hydraulic drive device.

Hydraulic drive devices are mostly designed in such a way that one or more motor-pump unit(s) can cover all required performances in a working cycle. Usually it is considered that electric motors can be operated for a short time also significantly above their nominal load.

If, however, a higher performance is required just once in a working cycle, this has mostly to be realized with additional or more powerful motors and/or pumps. As a consequence, also the overall connected load of the system is increasing.

Alternatively, hydraulic accumulators are frequently used in such cases. Hydraulic accumulators can be charged in break periods and the hydraulic oil accumulated under pressure can be re-extracted for covering peak loads. Here, the disadvantage clearly lies in the bad efficiency factor and, thus, in the higher energy consumption. Also the additional and regularly necessary safety inspections of the accumulators are not popular with the operators.

A drive device with an electric motor, a hydro pump and a centrifugal mass is disclosed in the DE 197 01 671 B4. This device is suitable for the execution of different working cycles with differently changing power requirement. This is reached in that the electric motor is connected with a rotational shaft of the hydro pump via a coupling for enabling an interruption of the torque transmission and that a control device is provided with which the power release of the electric motor is increased or decreased in dependence of the rotational speed of the flywheel each falling below or exceeding a predetermined rotational speed of the flywheel. There it is disadvantageous that for the change of the power release among others a complex mechanic coupling is necessary.

The DE 10 2010 035 283 A1 discloses a hydraulic drive device, wherein a frequency-controlled drive motor is permanently fixed via its motor shaft to (at least) one flywheel and to (at least) one unregulated hydraulic pump. Thereby, a maximal torque release is enabled with each rotational speed. Among others it is disadvantageous that the drive motor is steadily connected with the flywheel. Thus, a permanent dependency between drive motor, hydraulic pump and flywheel is given.

The object of the present invention therefore is to establish an improved hydraulic drive device compared to the prior art.

This is reached by a hydraulic drive device with the features of claim 1. Preferred embodiments are specified in the sub-claims. Hence, according to the invention the hydraulic drive device comprises at least one second hydraulic pump which is connected or can be connected with the at least one flywheel and a hydraulic connection conduct between the first hydraulic pump and the second hydraulic pump. Thereby it is possible that the second hydraulic pump together with the flywheel is additionally used when peak loads occur. Thus, the efficiency of the whole hydraulic drive device is substantially improved.

According to a preferred embodiment a first hydraulic switching element is provided, by which the hydraulic connection conduct can be shut off between the first hydraulic pump and the second hydraulic pump. The large advantage of this solution in comparison to the DE 197 01 671 B4, showing a pump-flywheel unit, is the fact that the energy accumulated in the flywheel is retrievable via a simple switching element (for example a hydraulic valve) rather than via a complex and mechanic couplings.

Two variants are possible for the construction of the pumps. According to a first variant it is provided that the swept volume of the at least one first hydraulic pump and/or the at least one second hydraulic pump are/is variable. Thus, the delivery volume can be adjusted or changed. Particularly preferred it is provided that the swept volume of the at least one second hydraulic pump is variable between a loading position and an unloading position for the loading or unloading the flywheel. For example it is possible that a relative small motor is used for the first hydraulic pump, whereby the loading of the flywheel can be effected relative slow via the connection conduct and the second pump. The swept volume of the second pump can be relative large for the unloading, whereby the consumer is supplied with a large amount of hydraulic liquid by actuating the second pump together with the flywheel.

According to a second variant it is provided that the at least one first hydraulic pump and/or the at least one second hydraulic pump are/is built as a fixed displacement pump. Thus, always the same volume per time period is delivered with this pump or these pumps.

For the motor is preferably provided that the rotational speed of the motor is variable. This rotational speed is signed. Thus, also the rotational direction can be changed.

Further it is preferred provided that the at least one motor and the at least one first hydraulic pump are coupled by a common drive shaft.

According to a further preferred embodiment it is provided that the hydraulic drive device comprises an open or closed loop control unit. By this open or closed loop control the motor, the first hydraulic pump, the second hydraulic pump and/or the first switching element can be controlled or regulated. A single open or closed loop control unit is preferably provided by which all components of the hydraulic drive device are controllable.

Particularly preferred the open or closed loop control unit can be used to couple the at least one first hydraulic pump via the first hydraulic switching element with the at least one second hydraulic pump, so that hydraulic liquid can be delivered by the at least one first hydraulic pump to the at least one second hydraulic pump. In a first phase a swept volume of the second hydraulic pump can be adjusted by the open or closed loop control unit in such a way that this second hydraulic pump is working as a hydraulic motor and is thereby accelerating the flywheel. In a second phase a swept volume of the second hydraulic pump can be adjusted by the open or closed loop control unit in such a way that this second hydraulic pump is working as a (supporting) pump driven by the flywheel.

Both of the pumps can deliver the hydraulic liquid into a common hydraulic conduct. In principle it is also possible that the at least two pumps (each in stand-alone operation) are supplying separated systems. Preferably it is provided that the at least on first hydraulic pump and the at least one second hydraulic pump are connected in parallel. Thereby it is preferably provided that in the parallel connection the flowing direction of the hydraulic liquid can be switched by changing the rotational speed of the motor and/or by changing the swing angle of the at least one first hydraulic pump and/or by a gear connected in between the motor and the first hydraulic pump. Here it can be provided that in the parallel connection the flowing direction of the hydraulic liquid can be switched by a second hydraulic switching element, preferably a 4/3-way valve. This switching is effected preferably by the open or closed loop control unit (not manually). With the parallel connection a charge pump and/or a pressure accumulator can be provided by which the parallel connection is put under pressure. Thereby, a pressure in the parallel connection can be established so that no cavitation occurs. The pressure accumulator can be built in the form of a bladder accumulator, a piston-cylinder unit or the like.

In principle the first and the second pump can be formed identically (this means constructed in the same way). However, in order to ensure an efficient adaptation to the conditions in the respective hydraulic drive device, the first pump and the second pump can be different, preferably with respect to their maximum rotational speed.

In order to ensure an interaction during operation of the hydraulic drive device which is fast and exact as possible, a sensor is provided by which a signal is detectable, which signal represents the rotational speed of the flywheel and/or the second hydraulic pump. By the open or closed loop control unit, to which the signal can be delivered, fluctuations of the volume flow of the hydraulic liquid can be compensated by controlling or regulating the at least one first pump and/or by controlling or regulating the at least one second pump and/or by controlling or regulating the motor

According to the invention, with other words, a motor-pump unit for operating at least one consumer is used. There, the motor-pump unit can be connected to an additional second hydraulic pump via a first hydraulic switching element, wherein the second hydraulic pump is or can be again (only) coupled with a flywheel. This means that the first hydraulic pump can bring the second hydraulic pump with the associated flywheel to a desired rotational speed and, thus, brings an additional hydraulic axis to performance. If now a higher performance than the (first) motor-pump combination is necessary, this can be activated via the same switching valve. There, the delivering direction of the second pump should be inverted, which can be realized in the easiest case with a regulating pump and an inverted swing angle deflection. Of course, also other variants for the “delivery flow inversion” are possible (for example switching via hydraulic valves of a suction-pressure conduct, etc.). The hydraulic performance can be doubled theoretically without increasing the connected load. The hydraulic performance can not only be doubled but also multiplied, if, for example, the second hydraulic pump is larger by a multiple that the first hydraulic pump or can be operated with higher rotational speed than the first hydraulic pump. When arranging several second hydraulic pumps with flywheels which can be “loaded” in sequence, the hydraulic peak performance could even be multiplied.

Protection is also sought for a molding machine, in particular an injection molding machine, comprising at least one consumer, wherein this consumer can be driven by a hydraulic drive device according to the invention. Such a consumer can be for example a hydraulic actuator, in particular a hydraulic cylinder or a hydraulic motor.

The object according to the invention is also solved by a method with the features of claim 18. Hence, the hydraulic liquid, preferably hydraulic oil, is delivered between the first hydraulic pump and the second hydraulic pump via the connection conduct. Also with this method the hydraulic drive device comprises a first hydraulic switching element by which the hydraulic connection conduct can be shut off between the first hydraulic pump and the second hydraulic pump. Moreover, an open or closed loop control unit is preferably provided by which the first hydraulic switching element controlled, and wherein by the open or closed loop control unit the at least one first hydraulic pump is coupled via the first hydraulic switching element with the at least one second hydraulic pump, comprising the step delivering the hydraulic liquid between the at least one first hydraulic pump and the at least one second hydraulic pump in dependency of the switch position of the first hydraulic switching element.

In particular with this method the subsequently effected steps accelerating the flywheel and driving the second hydraulic pump by the flywheel are executed. The acceleration is effected in that the swept volume of the hydraulic pump is adjusted by the open or closed loop control unit in such a way that the second hydraulic pump is working as a hydraulic motor for accelerating the flywheel. The driving of the second hydraulic pump via the flywheel is effected by adjusting the swept volume of the second hydraulic pump through the open or closed loop control unit.

All preferred embodiments of the hydraulic drive device analogously apply also to the method and vice versa.

Further details and advantages of the present invention are described more fully hereinafter by means of the specific description with reference to the embodiments illustrated in the drawings, in which:

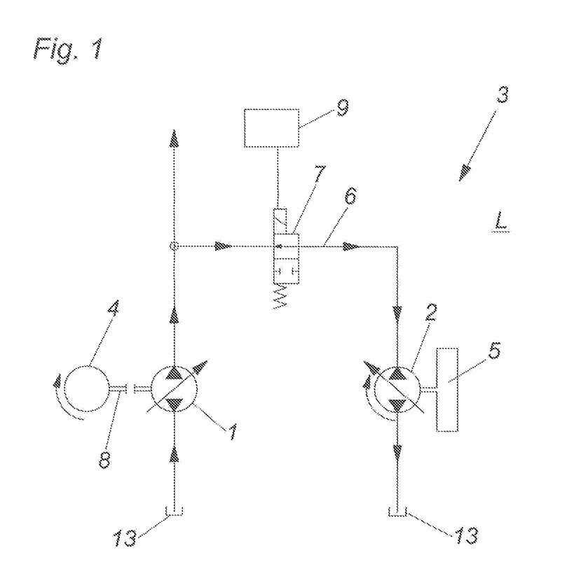

FIG. 1 schematically shows a hydraulic drive device when loading the flywheel,

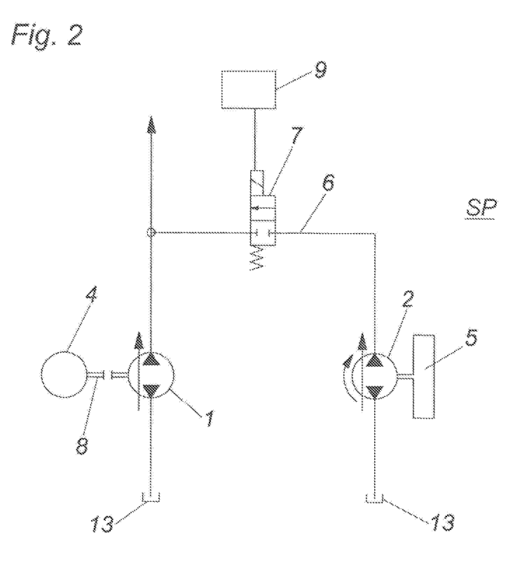

FIG. 2 schematically shows the hydraulic drive device with the flywheel when accumulating,

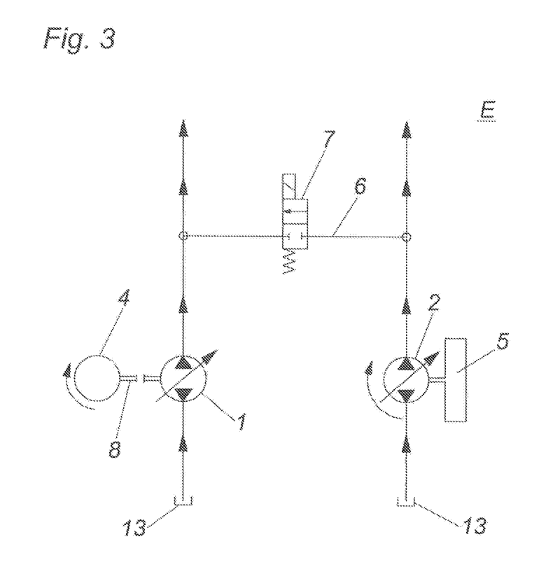

FIG. 3 schematically shows the hydraulic drive device when extracting form the stand-alone systems,

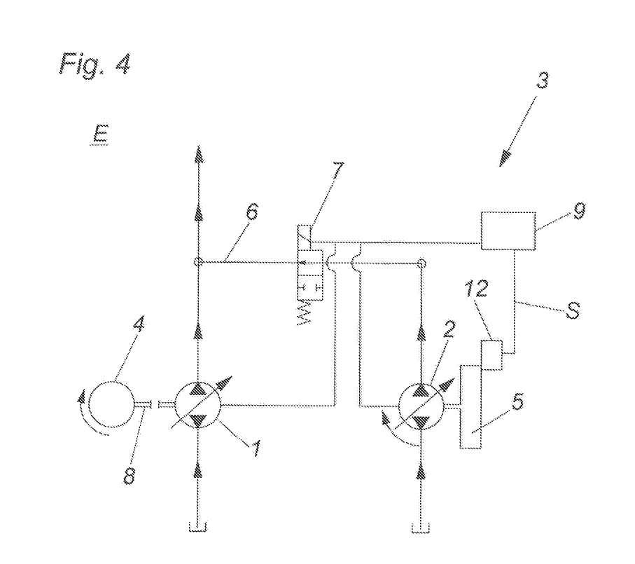

FIG. 4 schematically shows the hydraulic drive device when extracting form the overall system,

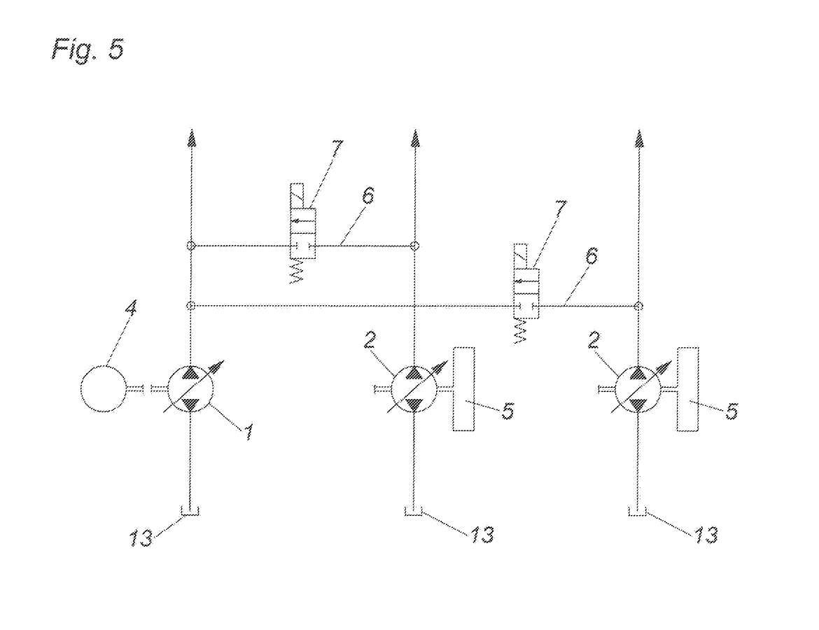

FIG. 5 schematically shows a hydraulic drive device with several flywheels and connection conducts,

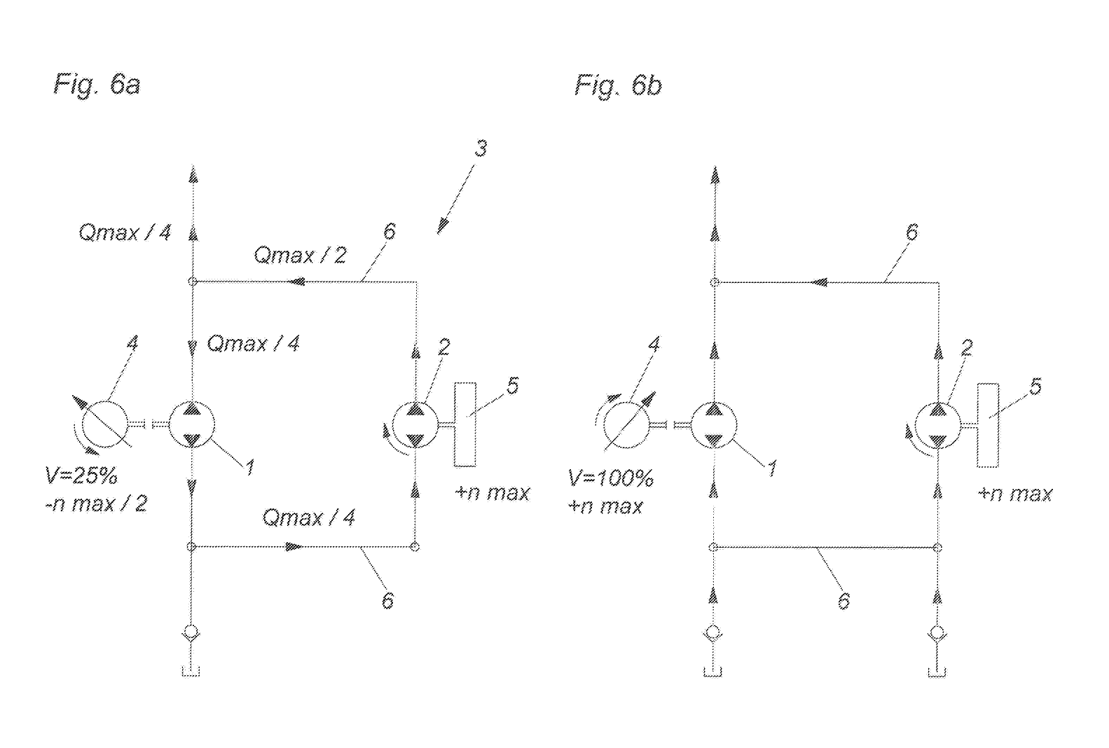

FIGS. 6a & 6b schematically shows a hydraulic drive device with a parallel connection in different switching positions,

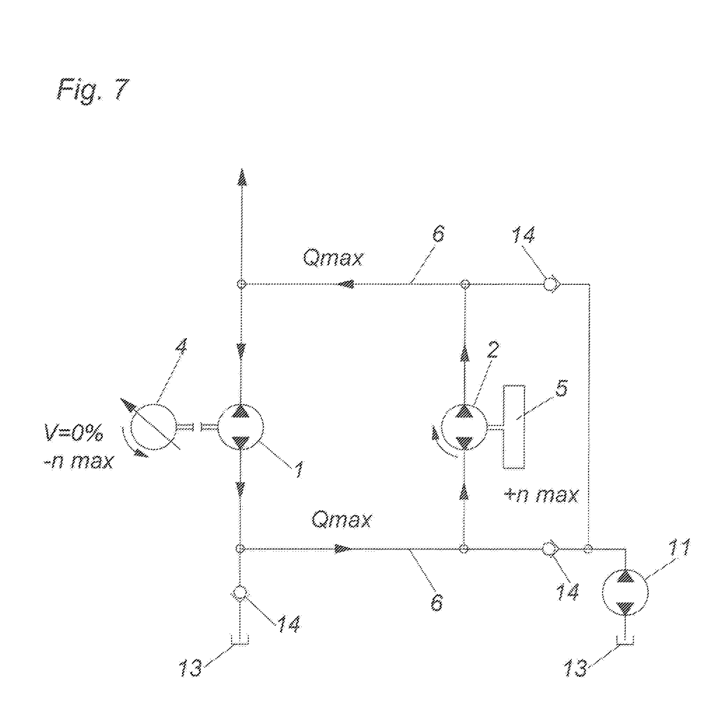

FIG. 7 schematically shows a hydraulic drive device in accumulation mode,

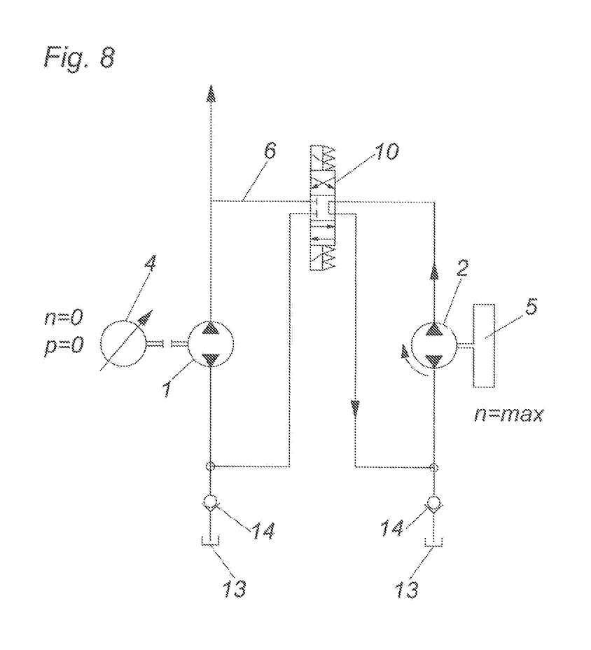

FIG. 8 schematically shows a loaded hydraulic drive device and

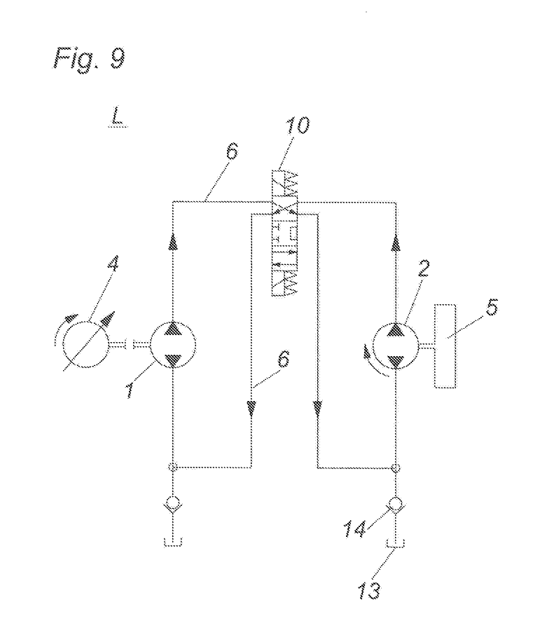

FIG. 9 schematically shows a hydraulic drive device when loading.

In FIG. 1 a basic version of a hydraulic drive device 3 is shown. The first hydraulic pump 1 is driven by a motor 4, preferably by an electric motor (or a hydro motor), via a shaft 8. At least one further (second) hydraulic pump 2 is provided, the axis of which is connected with a mechanic flywheel 5 rather than with an ordinary electric motor. Further, a connection conduct 6 (with a hydraulic switching element 7) is provided in order to being able to hydraulically connect the first pump 1 and the second pump 2. Each of the both pumps 1 and 2 is connected via a conduct with a tank 13 for hydraulic liquid (Of course also only one tank 13 can be provided instead of two separate tanks 13). The switching element 7 arranged in or at the connection conduct 6 is connected via a signal line with an open or closed loop control unit 9.

In the loading position L according to FIG. 1 the motor 4 drives the first pump 1. Via the switching element 7 the delivering flow of the first pump 1 is switched to the second pump 2, whereby the pump 2 is driven like a hydraulic motor and, thus, the second pump 2 begins to move together with the flywheel 5 and can reach a desired rotational speed. When having a suitable dimensioning of the flywheel 5, thus, a hydraulic power can be accumulated with the unit of a second pump 2 and a flywheel 5, which power is correspondingly activated when peak loads are needed.

With the drive unit consisting of the motor 4 and the first pump 1 it is basically irrelevant, whether there is a regulating pump or a fixed displacement pump, or also whether there is an electric motor with a constant or a variable rotational speed. Advantageous is an embodiment with at least one variable degree of freedom (rotational speed of the motor and/or swing angle of the pump).

If the second hydraulic pump 2 is implemented as a regulating pump, several advantages yield: For example, the second hydraulic pump 2 implemented in FIG. 1 as a regulating pump is just brought into the negative swing angle range (suction mode) and is, thus, accelerated via the delivering flow of the first hydraulic pump 1, so that the second hydraulic pump 2 delivers the delivering flow of the first hydraulic pump 1 back into the tank 13.

The possibility of a variable negative swing angle of the second hydraulic pump 2 provides the advantage in the loading mode or in the loading position L, that the required torque for accelerating the flywheel 5 is adjustable via the swing angle of the second hydraulic pump 2, which provides an optimal controllability when ramping-up the flywheel 5.

Further, the second pump 2 could comprise a significantly larger delivering volume than the first hydraulic pump 1 and a loading operation is still possible. Exemplary a first hydraulic pump 1 with a swept volume of 70 ccm/revolution achieves maximal 100 liters/minute when having 1500 revolutions/minute. A second hydraulic pump twice as large with a swept volume of 140 ccm/revolution would, however, only swing back to −50% during the loading operation. The torque introduced into the disk flywheel would indeed just be half as large as when the fully negative swing angle would be effective, however, this would only have the consequence that the loading operation would last twice as long.

By further reducing the negative swing angle of the pump 2, a further advantage is that it would even be possible to bring the flywheel system to a significantly higher rotational speed than the motor-pump system. In doing so it is completely irrelevant whether the pump 2 is larger, as large, or smaller than the pump 1.

With the accumulation shown in FIG. 2, the implementation of the second hydraulic pump 2 as a regulating pump has the advantage that after a separation of the both pump systems by switching the switching element 7, the second hydraulic pump 2 can be set to a zero displacement and, thus, no unnecessary amount has to be circulated in the accumulating mode or in the accumulating position SP. This means, the lost energy of the flywheel-pump unit is reduced to a minimum, as the hydraulic losses are least in zero displacement. In this phase the first hydraulic pump 1 can optionally be switched off, be driven in stand-by (pump in pressure regulation), or be used for another consumer.

After the pump-flywheel unit is autonomously running (without energy supply) with the desired rotational speed, the hydraulic performance of the pump-flywheel unit can be retrieved at any time (like with every other pump system) via a positive control of the swing angle of the second hydraulic pump 2. This can be made separate of each single system, whereby two different consumers (not shown) are operated in parallel (FIG. 3). The available performance for a consumer (not shown) can be increased by interconnecting the first hydraulic pump 1 and the second hydraulic pump 2 (FIG. 4). Also variants are possible where a motor-pump unit operates several pump-flywheel systems. These units and systems can optionally also be interconnected or be driven separately for the extraction (FIG. 5). Particularly advantageous is with all of these systems that the valves (switching elements 7) for the loading operations are simultaneously used for the switching-on and the switching-off of the pump-flywheel units during the extraction.

To FIG. 4 it can be quoted that a sensor 12 is shown exemplary by which a signal S can be detected, which signal S represents the rotational speed of the flywheel 5 or the pump 2. This signal S is transmitted to the open or closed loop control unit 9, which transmits corresponding control impulses to the first hydraulic switching element 7, to the first hydraulic pump 1 and/or to the second hydraulic pump 2 in order to compensate fluctuations of the volume flow of the hydraulic liquid. In particular, a measurement and evaluation of the rotational speed can thereby be effected for the pump-flywheel unit. It is useful to equip the pump-flywheel unit with a rotational-speed sensor (sensor 12) in order to optimally control the loading process on the one hand and in order to also know the exact delivering volume of the unit during the extraction (by knowledge of the exact rotational speed and of the swing angle of the second hydraulic pump 2) on the other hand. Thus, even a regulation can be established which holds the delivering volume of a pump-flywheel unit constant or at a desired value, although the rotational speed of the unit will inevitably decrease during the power extraction. Only the swing angle of the second hydraulic pump 2 has to be increased correspondingly. The minimum delivery amount of the system is then determined by a minimally permissible rotational speed and the maximum swing angle of the second hydraulic pump.

Exemplary a pump-flywheel unit is brought to 2000 rotations/minute. During the extraction the rotational speed decreases to about 1500 rotations/minute. Parallel thereto the swing angle of the pump 2 is increased form 75% to 100% in dependency of the actual rotational speed. Thus, the outer delivering volume of the system stays constant.

In contrast to the solution with the regulating pump on the swing axis, the variant with “fixed displacement pump+flywheel” is primarily different in that the reversal of the delivering flow between loading and extracting is not possible by the second hydraulic pump 2 itself. Either the constant delivery flow has to be switched by corresponding additional actions (switching from pressure conduct to suction conduct) or an adjustable loading unit is combined in such a way that the delivering volume of the pump-flywheel unit can be completely “suctioned away” and, thus, a closed circulation emerges.

According to FIG. 6a a delivering with 25% (Qmax/4) takes place to the consumer (not shown). Therefore, the first hydraulic pump 1 is driven by a motor 4 with a variable rotational speed (rotational speed V=25%). This motor-pump unit is able to completely “suction away” the delivering volume of the second hydraulic pump 2 by the inversion of the rotation direction (−n max/2) and, thus, generating an outer delivering volume of zero. The overall delivering volume can be selectively increased by reducing the “negative” rotational speed.

With maximal “positive” rotational speed (V=100; +n max) the maximum delivering volume of the overall system is reached (see FIG. 6b).

FIG. 7 shows an accumulation mode with a fixed displacement pump-flywheel combination. “V=0%” means that the outer volume flow is zero. “−n max” means that the first hydraulic pump 1 rotates with maximum negative rotational speed and, therefore, “suctions away” the overall delivering volume of the second hydraulic pump 2. Additionally, a feeding pump 11 is present with which the conducts (arranged in parallel connection) of the hydraulic drive device 3 are impinged with pressure (preferably with 5 bar). Also check valves 14 are present.

When having a hydraulic drive device 3 with a fixed displacement pump there is also the possibility of a switching via a direction valve. With this variant shown in FIGS. 8 and 9 the oil flow of the pump 2 is switched via a corresponding second hydraulic switching element 10 in such a way that three possibilities unfold when having the same rotational direction of the second hydraulic pump 2: Loading (FIG. 8), “Loaded” (FIG. 9—stand-by or unpressurized revolution) and extraction (not shown). The second hydraulic switching element 10 is formed as a 4/3-ways valve. An internal cycle between the flywheel 5, the second hydraulic pump 2 and the switching element 10 is given by the switching position of the second hydraulic switching element 10 shown in FIG. 8. In contrast, the motor 4 is at standstill. In FIG. 9 the second hydraulic switching element 10 is situated in a switching position which corresponds to the loading position L, whereby the second hydraulic pump 2 and the flywheel 5 are loaded via the motor 4, the first hydraulic pump 1 and the connection conduct 6.

1. A hydraulic drive device, in particular for a molding machine, comprising:
at least one motor, in particular an electric motor,
least one first hydraulic pump which can be driven by the at least one motor, and
at least one flywheel,
wherein
at least one second hydraulic pump is provided, which is connected or can be connected with the at least one flywheel, and that
hydraulic connection conduct is provided between the first hydraulic pump and the second hydraulic pump.

2. The drive device according to claim 1, wherein a first hydraulic switching element is provided, by which the hydraulic connection conduct can be shut off between the first hydraulic pump and the second hydraulic pump.

3. The drive device according to claim 1, wherein the swept volume of the at least one first hydraulic pump and/or the at least one second hydraulic pump are/is variable.

4. The drive device according to claim 3, wherein the swept volume of the at least one second hydraulic pump is variable between a loading position and an unloading position for the loading or unloading the flywheel.

5. The drive device according to claim 1, wherein the at least one first hydraulic pump and/or the at least one second hydraulic pump are/is built as a fixed displacement pump.

6. The drive device according to claim 1, wherein the rotational speed of the motor is variable.

7. The drive device according to claim 1, wherein the at least one motor and the at least one first hydraulic pump are coupled by a common drive shaft.

8. The drive device according to claim 1, wherein an open or closed loop control unit is provided by which the first hydraulic switching element can be triggered and wherein the open or closed loop control unit is able to couple the at least one first hydraulic pump via the first hydraulic switching element with the at least one second hydraulic pump, so that hydraulic liquid can be delivered by the at least one first hydraulic pump to the at least one second hydraulic pump.

9. The drive device according to claim 8, wherein a swept volume of the second hydraulic pump can be adjusted by the open or closed loop control unit in such a way that this second hydraulic pump is working as a hydraulic motor and is thereby accelerating the flywheel.

10. The drive device according to claim 8, wherein a swept volume of the second hydraulic pump can be adjusted by the open or closed loop control unit in such a way that this second hydraulic pump is working as a pump driven by the flywheel.

11. The drive device according to claim 1, wherein the at least on first hydraulic pump and the at least one second hydraulic pump are connected in parallel.

12. The drive device according to claim 11, wherein in the parallel connection the flowing direction of the hydraulic liquid can be switched by changing the rotational speed of the motor and/or by changing the swing angle of the at least one first hydraulic pump and/or by a gear connected in between the motor and the first hydraulic pump.

13. The drive device according to claim 11, wherein in the parallel connection the flowing direction of the hydraulic liquid can be switched by a second hydraulic switching element, preferably a 4/3-way valve.

14. The drive device according to claim 11, wherein a charge pump and/or a pressure accumulator are/is provided by which the parallel connection is put under pressure.

15. The drive device according to claim 1, wherein a sensor is provided by which a signal is detectable, which signal represents the rotational speed of the flywheel and/or the second hydraulic pump.

16. The drive device according to claim 15, wherein an open or closed loop control unit is provided to which the signal can be delivered, wherein the open or closed loop control unit is constructed to compensate fluctuations of the volume flow of the hydraulic liquid by controlling or regulating the at least one first pump and/or by controlling or regulating the at least one second pump and/or by controlling or regulating the motor.

17. A molding machine comprising a drive device according to claim 1.

18. A method for operating a hydraulic drive device, in particular according to claim 1, wherein the hydraulic drive device comprises at least one motor, in particular an electric motor, at least one first hydraulic pump which can be driven by the at least one motor and at least one flywheel, characterized in that the hydraulic drive device comprises at least one second hydraulic pump which is connected or can be connected with the at least one flywheel, and that a hydraulic connection conduct is provided between the first hydraulic pump and the second hydraulic pump, with the step: delivering hydraulic liquid between the first hydraulic pump and the second hydraulic pump via the connection conduct.

19. The method according to claim 18, characterized in that the hydraulic drive device comprises a first hydraulic switching element by which the hydraulic connection conduct can be shut off between the first hydraulic pump and the second hydraulic pump.

20. The method according to claim 19, wherein an open or closed loop control unit is provided by which the first hydraulic switching element is controlled, and wherein by the open or closed loop control unit the at least one first hydraulic pump is coupled via the first hydraulic switching element with the at least one second hydraulic pump 94, comprising the step: delivering the hydraulic liquid between the at least one first hydraulic pump and the at least one second hydraulic pump in dependency of the switch position of the first hydraulic switching element.

21. The method according to claim 20, comprising the step: accelerating the flywheel by adjusting the swept volume of the hydraulic pump through the open or closed loop control unit in such a way that the second hydraulic pump is working as a hydraulic motor for accelerating the flywheel.

22. The method according to claim 20, comprising the step: driving the second hydraulic pump via the flywheel by adjusting the swept volume of the second hydraulic pump through the open or closed loop control unit.
